(19) United States
(12) Patent Application Publication
(10) Pub. No.: US 2025/0093482 A1
(43) Pub. Date: Mar. 20, 2025

(54) LASER RANGING SIGHT

(71) Applicant: SHENZHEN RUIERXING ELECTRONIC CO., LTD., Shenzhen (CN)

(72) Inventors: Luxin Fu, Shenzhen (CN); Zhicheng Xing, Shenzhen (CN)

(21) Appl. No.: 18/523,887

(22) Filed: Nov. 30, 2023

(30) Foreign Application Priority Data
Sep. 15, 2023 (CN) 202311200693.4

(51) Int. Cl. G01S 7/497; G01S 7/481; G01S 17/08; G01S 17/89

(52) U.S. Cl. CPC G01S 7/497; G01S 7/4813; G01S 17/08; G01S 17/89

(57) ABSTRACT

Disclosed is a laser ranging sight, which includes a housing and a laser emitting device, a laser receiving device and an imaging device arranged in the housing. Optical paths of the laser emitting device, the receiving device and the imaging device collectively form a ranging optical path. The laser ranging sight further includes an adjusting component provided to the housing, and the adjusting component is disposed at a front side of the laser emitting device, the laser receiving device and the imaging device. The adjusting component is operatable to change an orientation of the ranging optical path.

### CROSS-REFERENCE TO RELATED APPLICATIONS

The present disclosure claims priority of Chinese Invention application No. 202311200693.4, filed on Sep. 15, 2023, the entire contents of which are hereby incorporated by reference.

### TECHNICAL FIELD

The present disclosure relates to the technical field of sighting device, and in particular to a laser ranging sight.

### BACKGROUND

Laser ranging technology utilizes laser to accurately measure the distance to the target object, sometimes it is also necessary to aim at and image the target object. As a result, the adjustment of the orientation of the laser emitting optical path, laser receiving optical path and imaging optical path is very important. The typical laser ranging sights each may adopt an optical reticle, and a prism assembly or variable-magnification reverse lens assembly, most of which use linkage mechanisms to move and adjust the optical paths. However, the structures of those linkage mechanisms are relatively complicated and therefore are difficult to process. and the adjustment operation is cumbersome.

### SUMMARY

An object of the present disclosure is to provide a laser ranging sight, which provides improved adjusting component, optimizing the structure and improving the convenience of operation.

To achieve the above object, the technical solution provided by the invention is a laser ranging sight, including: a housing; and a laser emitting device, a laser receiving device, and an imaging device arranged in the housing, wherein optical paths of the laser emitting device, the receiving device and the imaging device collectively form a ranging optical path, wherein the laser ranging sight further includes an adjusting component mounted on the housing, and the adjusting component is disposed at a front side of the laser emitting device, the laser receiving device and the imaging device, and the adjusting component is operatable to change an orientation of the ranging optical path.

In some embodiments, the laser ranging sight further includes a reflective optical element provided at the front side of the laser emitting device, the laser receiving device and the imaging device, the adjusting component is connected to the reflective optical element, and the orientation of the ranging optical path is changed by steering the reflective optical element.

In some embodiments, the imaging device is a digital imaging device or an optical imaging device.

In some embodiments, the reflective optical element is a lens or a prism.

In some embodiments, the adjusting component is manually operated or electrically driven.

In some embodiments, the adjusting component includes an adjusting knob and an adjusting seat, the adjusting knob is partially exposed outside the housing, the adjusting seat is connected to the reflective optical element, and when the adjusting knob is operated, the adjusting knob acts on the adjusting seat and drives the reflective optical element to rotate.

In some embodiments, the adjusting seat is provided with a reset spring, and the reset spring provides a return force for driving the adjusting seat together with the reflective optical element to rotate in a return direction.

In some embodiments, the adjusting knob includes an up-down adjusting knob and the adjusting seat includes an up-down adjusting seat, the up-down adjusting knob abuts against the adjusting seat, and the up-down adjusting seat is rotatably connected to the housing and is rotatable relative to the housing about a first axis.

In some embodiments, the adjusting knob further includes a left-right adjusting knob and the adjusting seat further includes a left-right adjusting seat, wherein the left-right adjusting knob abuts against the left-right adjusting seat, the left-right adjusting seat is rotatably connected to the up-down adjusting seat and is rotatable about a second axis with respect to the up-down adjusting seat, and the second axis is perpendicular to the first axis.

In some embodiments, the reflective optical element is connected to one of the up-down adjusting seat and the left-right adjusting seat.

In some embodiments, the adjusting seat further includes a mounting seat fixed to the housing, and wherein the mounting seat, the up-down adjusting seat and the left-right adjusting seat are sequentially disposed along the second axis, and the up-down adjusting seat is rotatably connected to the mounting seat.

In some embodiments, the mounting seat is provided with two first bores spaced apart along the first axis, and the up-down adjusting seat is provided with two up-down adjusting shafts that engage in corresponding two first bores respectively, such that the up-down adjusting seat is rotatably connected to the mounting seat through the two up-down adjusting shafts.

In some embodiments, the up-down adjusting seat is provided with a second bore penetrating therethrough along the second axis, the left-right adjusting seat is protruded with a left-right adjusting shaft extending along the second axis, and the left-right adjusting shaft is engaged with the second bore, such that the left-right adjusting seat is rotatably connected to the up-down adjusting seat through the left-right adjusting shaft.

In some embodiments, the mounting base is provided with a third bore penetrating therethrough along the second axis, and the up-down adjusting knob passes through the third bore and abuts against the up-down adjusting seat.

In some embodiments, an up-down reset spring is provided between the mounting seat and the up-down adjusting seat, when the up-down adjusting knob is screwed in, the up-down adjusting knob pushes an end of the up-down adjusting seat downwardly and deforms the up-down reset spring; and when the up-down adjusting knob is screwed out, the up-down reset spring returns and drives the end of the up-down adjusting seat to rotate in a return direction.

In some embodiments, the mounting seat is formed with an accommodation cavity, the up-down adjusting seat is at least partially disposed within the accommodation cavity and is rotatably connected to the mounting seat, the mounting seat has an opening towards the reflective optical element, and the left-right adjusting seat and the reflective optical element are exposed outside the accommodation cavity through the opening.

In some embodiments, the opening is inclined, and an inclination angle of the opening coincides with an inclination angle of the reflective optical element.

In some embodiments, the up-down adjusting seat is provided with a left-right reset spring, the left-right adjusting knob abuts against a contact point of the left-right adjusting seat, when the left-right adjusting knob is screwed in, the left-right adjusting knob pushes the left-right adjusting seat to rotate about the second axis, and the left-right reset spring is compressed; and when the left-right adjusting knob is screwed out, the left-right reset spring pushes the left-right adjusting seat to rotate in a return direction.

In some embodiments, the laser ranging sight further includes another reflective optical element provided opposite the reflective optical element, and the another reflective optical element is fixedly disposed in the housing.

In some embodiments, the laser emitting device and the laser receiving device are disposed in parallel on two sides of the imaging device.

In embodiments of this application, the optical paths of the laser emitting device, the laser receiving device and the imaging device collectively form a ranging optical path. The adjusting component is disposed at the front side of the laser emitting device, the laser receiving device and the imaging device. The orientation of the ranging optical path can be adjusted integrally, and a complicated linkage mechanism can be omitted, thus the operation is simplified.

### BRIEF DESCRIPTION OF THE DRAWINGS

FIG. 1 is a schematic structural view of a laser ranging sight according to a first embodiment of the present disclosure;

FIG. 2 is a schematic view showing an internal structure of the laser ranging sight according to FIG. 1;

FIG. 3 is a schematic view of a laser emitting optical path of the laser ranging sight according to FIG. 1;

FIG. 4 is a schematic view of a laser receiving optical path of the laser ranging sight according to FIG. 1;

FIG. 5 is a schematic view of an imaging optical path of the laser ranging sight according to FIG. 1.

FIG. 6 is a schematic structural view of an adjusting component of the laser ranging sight according to FIG. 1;

FIG. 7 is an explosive schematic structural view of the adjusting component according to FIG. 1;

FIG. 8 is an explosive schematic structural view of the adjusting component according to FIG. 1 from another aspect;

FIG. 9 is a schematic view of an internal structure of a laser ranging sight according to a second embodiment of the present disclosure;

FIG. 10 is a schematic view showing an internal structure of a laser ranging sight according to a third embodiment of the present disclosure;

FIG. 11 is a schematic structural view of a laser ranging sight according to a fourth embodiment of the present disclosure.

### DESCRIPTION OF THE EMBODIMENTS

The technical solutions of the embodiments of the present disclosure are described clearly and completely in detail below in combination with drawings in the embodiments of the present disclosure. Evidently, the embodiments described above are merely a portion of the embodiments of the present disclosure, but not all of the embodiments. Based on the embodiments of the present disclosure, all other embodiments, which are obtained by those skilled in the art without creative work, fall within the protection scope of the present disclosure.

It should be noted that when a component is referred to as being “connected” to another component, it may be directly connected to another component, or there may also be a component arranged intermediately. When a component is considered to be “provided/arranged” on another component, it may be directly provided/arranged on another component or there may also be a component arranged intermediately.

Unless otherwise defined, all technical and scientific terms used herein have the same meaning as commonly understood by those skilled in the art of the present disclosure. The terms used herein in the specification of the present disclosure are only for illustration of specific embodiments, and are not intended to limit the present disclosure.

It is also to be noted that orientation terms such as left, right, top and bottom in the embodiments are only a relative concept to each other, or referred to by taking a normal use state of a product as reference, and should not be regarded as limitation.

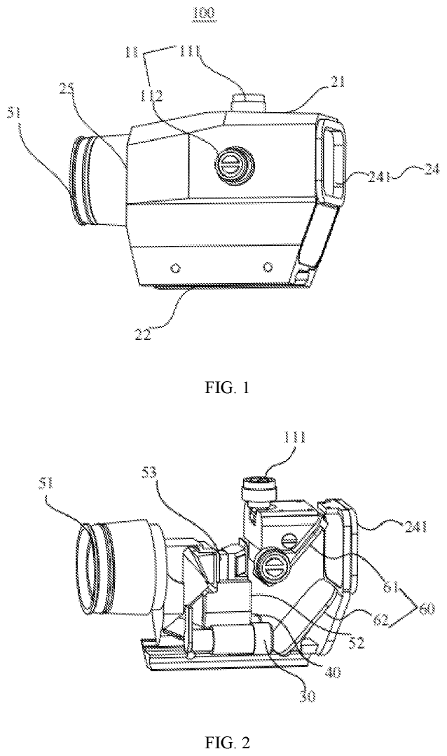

Referring to FIGS. 1, 2 and 6, a laser ranging sight 100 according to a first embodiment of the present disclosure includes a housing 20, with a laser emitting device 30, a laser receiving device 40, an imaging device 50 and an adjusting component arranged therein. The imaging device 50 is configured for aiming at and imaging a target object, the laser emitting device 30 is configured for emitting a laser to the target object, and the laser receiving device 40 is configured for receiving the laser reflected by the target object, thus the distance to the target object can be measured. The optical paths of the laser emitting device 30, the laser receiving device 40 and the imaging device 50 collectively form a ranging optical path, which can be considered as an integrated optical path. Among them, the optical paths of the laser emitting device 30, the laser receiving device 40 and the imaging device 50 are referred to as the laser emitting optical path, the laser receiving optical path and the imaging optical path, respectively.

The adjusting component 10 is disposed at a front side of the laser emitting device 30, the laser receiving device 40 and the imaging device 50 for changing the orientation of the ranging optical path, i.e., changing the orientation of the laser emitting optical path, the laser receiving optical path and the imaging optical path simultaneously.

In this embodiment, the laser emitting optical path, the laser receiving optical path and the imaging optical path collectively form a ranging optical path, which can be adjusted integrally. Thus a complicated linkage mechanism can be omitted. Moreover, since the adjusting component 10 is disposed at the front side of the laser emitting device 30, the laser receiving device 40, and the imaging device 50, the orientation of the ranging optical path can be changed simply by operating the adjusting component 10, which is simple to operate with high adjustment accuracy.

In order to more clearly show the position relationship of respective components of the laser ranging sight 100, some wires and electronic components are not shown in the drawings herein for clarity. In the description of orientation terms herein, a direction adjacent to/towards the target object is defined as the front side and a direction away from the target object is defined as the rear side. The direction of the optical path propagating horizontally is defined as the axial direction.

Specifically, as shown in FIG. 1, the housing 20 is a hollow body which opens at both axial ends. The housing has a top wall 21 and a bottom wall 22 opposite to each other in the axial direction, two side walls 23 opposite to each other in the right-left direction, and a front end 24 and a rear end 25 opposite to each other in the front-rear direction. The front end 24 of the housing 20 adjacent to the target object is opened to form an observation window 241, through which the laser and natural light enter the housing 20. The observation window 241 is disposed perpendicularly to the axial direction,

The imaging device 50 is arranged in the housing 20. The imaging device 50 of this embodiment is a white light imaging device configured for receiving natural light and imaging. The imaging device 50 includes an eyepiece 51 and an objective lens 52. The eyepiece 51 is disposed at the rear end 25 of the housing 20. The objective lens 52 is disposed between the front end 24 and the rear end 25 of the housing 20. The objective lens 52 has a cylindrical shape extending approximately in the axial direction. The eyepiece 51 may include a plurality of lenses, among which the plurality of lenses may be coupling lenses. It will be appreciated that the angle and relative position between the objective lens 52 and the eyepiece 51 may be any angles and relative positions that satisfy the optical imaging conditions. In this embodiment, a third optical element 603 for imaging may also be provided between the objective lens 52 and the eyepiece 51, which may be selected from known wedge-shaped lens, negative lens, roof prism, half-pentaprism, or any combinations thereof. The specific structure of the third optical element will not be described in detail herein.

The laser emitting device 30 and the laser receiving device 40 are disposed in parallel on two sides of the cylindrical objective lens 52. The laser emitting device 30 and the laser receiving device 40 are also substantially cylindrical in shape extending axially. Preferably, the laser emitting device 30 and the laser receiving device 40 are located at the bottom of the housing 20, with equal axial distances to the target object. The laser emitting device 30 includes a laser emitter and a laser emitting lens (not shown). The laser emitting lens is located at the front side of the laser emitter for collimating the laser parallel to a horizontal plane. The laser emitter is configured to emit the laser in a direction towards the target object. The laser receiving device 40 includes a laser receiver and a laser receiving lens (not shown). The laser receiving lens is located at the front side of the laser receiver for converging the laser reflected by the target object to the laser receiver. The laser receiver is configured to receive the laser converged by the laser receiving lens. Methods of measuring a distance to a target object using a laser are known in the art and will not be described herein.

The adjusting component 10 is disposed at the front side of the laser emitting device 30, the laser receiving device 40 and the imaging device 50, configured for changing the orientation of the ranging optical path. Specifically, the laser ranging sight 100 of this embodiment further includes a reflective optical element 60 provided at the front side of the laser emitting device 30, the laser receiving device 40, and the imaging device 50. The adjusting component 10 is connected to the reflective optical element 60, and the orientation of the ranging optical path is changed by changing the orientation of the reflective optical element 60.

The reflective optical element 60 includes at least a first reflective optical element 61 and a second reflective optical element 62 disposed oppositely. As shown in FIG. 2, the first reflective optical element 61 is connected to the adjusting component 10, and the orientation of the ranging optical path can be changed by steering the first reflective optical element 61. The first reflective optical element 61 is disposed at an angle relative to the observation window 241. A reflective surface of the first reflective optical element 61 faces towards the observation window 241 and faces away from the objective lens 52. In this embodiment, the reflective surface of the first reflective optical element 61 is arranged at approximately 45° to the plane on which the observation window 241 is located. The first reflective optical element 61 of this embodiment is arranged with its upper end facing forwardly (i.e. is relatively closer to the target object) and its lower end facing backwardly (i.e. is relatively distant from the target object), such that the first reflective optical element 61 is able to convert a vertical beam into a horizontal one to be emitted, or to convert a horizontal beam into a vertical one to be emitted. Preferably, the projection of the first reflective optical element 61 on the vertical plane falls within the region of the observation window 241, so as to ensure all the beams reflected by the first reflective optical element 61 are emitted through the observation window 241.

The second reflective optical element 62 is located below and substantially parallel to the first reflective optical element 61. A reflective surface of the second reflective optical element 62 faces towards the reflective surface of the first reflective optical element 61. Preferably the second reflective optical element 62 is located right below the first reflective optical element 61. That is to say, the projections of the first reflective optical element 61 and the second reflective optical element 62 on the horizontal plane coincide each other. Preferably, the projection of the second reflective optical element 62 on the vertical plane falls within the region of the objective lens 52, to ensure that all the beams reflected by the first reflective optical element 61 reach the objective lens 52. In the embodiment, the natural light reflected by the target object is successively reflected by the first reflective optical element 61 and the second reflective optical element 62, then reaches the objective lens 52, and is finally imaged by the eyepiece 51. It can be understood that the angle and relative position between the first reflective optical element 61 and the second reflective optical element 62 may be any angles and positions satisfying reflection conditions.

Preferably, the second reflective optical element 62 is fixed relative to the housing 20. In other embodiments, the adjusting component 10 may also be connected to the first reflective optical element 61 and the second reflective optical element 62, respectively, thus the steering of the two can be adjusted separately and independently by the adjusting component 10.

Referring to FIGS. 2, the first reflective optical element 61 and the second reflective optical element 62 are reflecting mirrors with the same dimensions. In other embodiments, the first reflective optical element 61 and the second reflective optical element 62 may also be prisms, or one of the two is a prism and the other is a reflecting mirror. In alternative embodiments, the reflective optical element 60 may further include a third reflective optical element or more reflective optical elements.

In this embodiment, the optical paths of the laser emitting device 30, the laser receiving device 40, and the imaging device 50 are independent from each other. FIG. 3 shows a schematic view of the laser emitting optical path from a side view. The optical path of the laser emitting device 30 starts from the laser emitter, which emits a laser beam with a certain specific wavelength band (e.g. 905 nm). The laser beam is collimated into a parallel beam after passing through the laser emitting lens, and is then successively reflected by the second reflective optical element 62 and the first reflective optical element 61, and finally arrives at the target object, thus forming the laser emitting optical path.

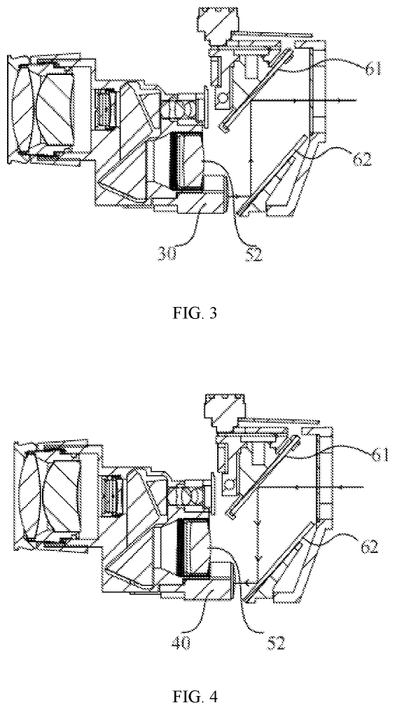

Referring to FIGS. 4, which illustrates a schematic view of the laser receiving optical path from a side view. The laser is reflected again by the target object after reaching the target object, thus the optical path of the laser receiving device 40 starts from the target object. Part of the laser reflected by the target object is successively reflected by the first reflective optical element 61 and the second reflective optical element 62, and then converged by the laser receiving lens, and finally reaches the laser receiver located behind the laser receiving lens, thus forming the laser receiving optical path.

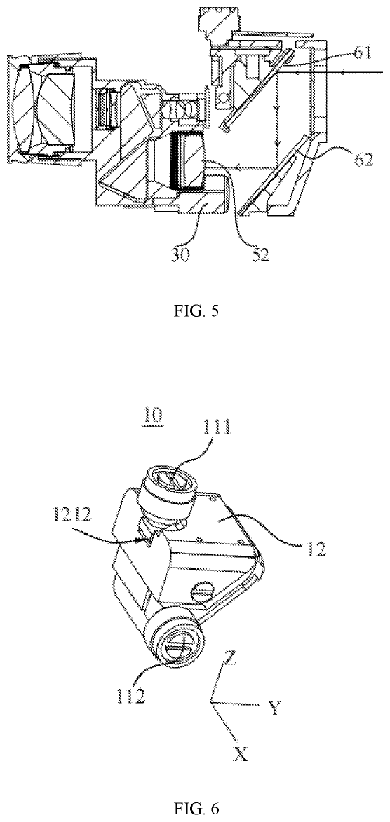

As shown in FIG. 5, it illustrates a schematic view of the imaging optical path from a side view. Similar to the optical path of the laser receiving device 40, the optical path of the imaging device 50 starts from the target object, and the natural light reflected by the target object is successively reflected by the first reflective optical element 61 and the second reflective optical element 62, and finally reaches the eyepiece 51, thus forming the imaging optical path.

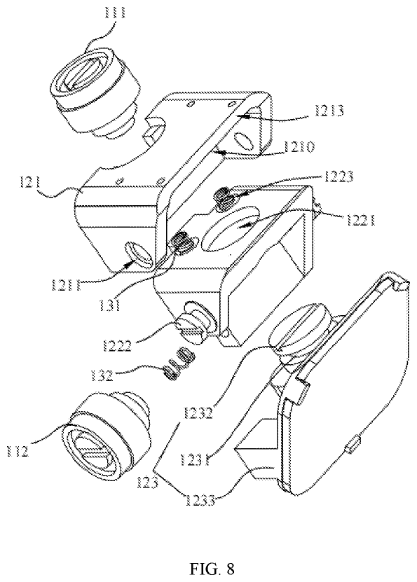

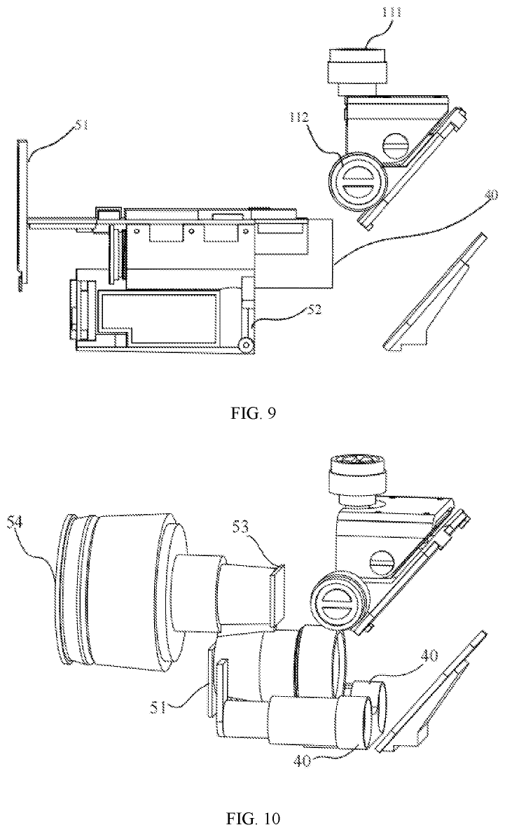

As shown in FIGS. 6 to 8, the adjusting component 10 of this embodiment includes an adjusting knob 11 and an adjusting seat 12. The adjusting seat 11 is connected to the first reflective optical element 61. The adjusting knob 11 is partially exposed outside the housing 20. When operating the adjusting knob 11, it acts on the adjusting seat 12 and drives the first reflective optical element 61 to rotate. Preferably, the adjusting seat 12 is provided with a reset spring 13, which provides a restoring force to the adjusting seat 12 and is used for driving the adjusting seat 12 together with the first reflective optical element 61 to rotate in the return direction. The return direction herein refers to a direction opposite to the direction in which the adjusting seat 12 drives the first reflective optical element 61 to rotate.

As shown in FIGS. 1 and 6, the adjusting knob 11 includes an up-down adjusting knob 111 and a left-right adjusting knob 112. The up-down adjusting knob 111 and the left-right adjusting knob 112 in this embodiment may be screws provided with scales corresponding to rotation angles of the reflective optical element 60. A first through hole is provided at the top of the housing 20 penetrating therethrough along the Z-axis at a position corresponding to the first reflective optical element 61. A second through-hole is provided in one of the side walls 23 penetrating therethrough along the X-axis direction at a position corresponding to the first reflective optical element 61. As shown in FIG. 6, the Z-axis is located on a vertical plane. The X-axis is perpendicular to the Z-axis and located on a horizontal plane. The up-down adjusting knob 111 is exposed outside the housing 20 through the first through hole, and the left-right adjusting knob 112 is exposed outside the housing 20 through the second through hole.

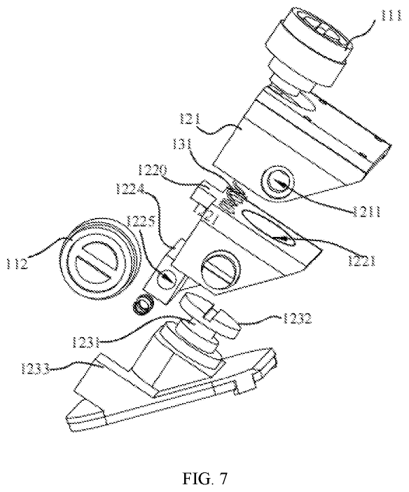

Specifically, the adjusting seat 12 includes an up-down adjusting seat 122 and a left-right adjusting seat 123 disposed sequentially from top to bottom. The up-down adjusting seat 122 is rotatably connected to the housing 20 and is rotatable about the X-axis with respect to the housing 20. As shown in FIG. 7, the up-down adjusting knob 111 abuts against a rear end of the up-down adjusting seat 122. When the up-down adjusting knob 111 is screwed in, the rear end of the up-down adjusting seat 122 is pushed down to drive the first reflective optical element 61 to rotate about the X-axis.

The left-right adjusting seat 123 is rotatably connected to the up-down adjusting seat 122 and is rotatable about the Z-axis with respect to the up-down adjusting seat 122. The left-right adjusting knob 112 abuts against the left-right adjusting seat 123. When the left-right adjusting knob 112 is screwed in, it pushes the left-right adjusting seat 123 to move inwardly towards the housing 20, thus driving the first reflective optical element 61 to rotate about the Z-axis.

In the present embodiment, the first reflective optical element 61 is connected to the left-right adjusting base 123, to be driven to rotate in the left-right direction. In other embodiments the first reflective optical element 61 may also be directly connected to the up-down adjusting seat 122, to be driven to rotate in the up-down direction.

Preferably, the adjusting seat 12 of this embodiment further includes a mounting seat 121 fixed relative to the housing 20. Referring to FIG. 7, the mounting seat 121, the up-down adjusting seat 122 and the left-right adjusting seat 123 are disposed in sequence along the Z-axis. The up-down adjusting seat 122 is rotatably connected to the housing 20 through the mounting seat 121 and is rotatable about the X-axis with respect to the housing 20. The mounting seat 121 has a shape substantially in right-angled trapezoid with a wide top and a narrow bottom, and includes a top side and a bottom side located on the horizontal plane, three sides perpendicular to the horizontal plane, and an inclined side. The first reflective optical element 61 is located on the inclined side of the mounting seat 121. The mounting seat 121 is formed with an accommodation cavity 1210. The up-down adjusting seat 122 is at least partially received within the accommodation cavity 1210 and rotatably connected to the mounting seat 121. The mounting seat 121 is provided with a first bore 1212 penetrating therethrough along the Z-axis, which communicates with the accommodation cavity 1210. The up-down adjusting knob 111 is engaged in the first bore 1212 and comes into contact with the up-down adjusting seat 122 through the first bore 1212.

The mounting seat 121 is provided with two second bores 1211 provided spaced apart along the X-axis. The up-down adjusting seat 122 is provided with two up-down adjusting shafts 1222 which is engaged with the corresponding second bores 1211, respectively, so that the up-down adjusting seat 122 is rotatably connected to the mounting seat 121 through the two up-down adjusting shafts 1222. The up-down adjusting shafts 1222 define the direction of the X-axis.

Preferably, as shown in FIG. 6, the first bore 1212 also runs through the mounting seat 121 in the Y-axis direction. In this embodiment, the Y-axis direction is also the axial direction of the laser ranging sight 100. The up-down adjusting seat 122 has an up-down adjusting contact point 1220 protruding from the first bore 1212. The up-down adjusting knob 111 abuts against the up-down adjusting contact point 1220, so as to facilitate the force-applying to the up-down adjusting seat 121. It would be appreciated that the first bore 1212 would not interfere with the movement of the up-down adjusting contact point 1220.

The up-down adjusting seat 122 is provided with a third bore 1221 penetrating therethrough along the Z-axis. The left-right adjusting seat 123 is protruded with a left-right adjusting shaft 1231 extending along the Z-axis, which is connected with a movable screw head 1232. The screw head 1232 is in a circular shape, with its outer diameter larger than an inner diameter of the third bore 1221. when assembled, the left-right adjusting shaft 1231 can be passed through the third bore 1221 from bottom to top, and then the left-right adjusting shaft 1231 is connected with the screw head 1232, thus the left-right adjusting seat 123 is connected to the up-down adjusting seat 122. When the left-right adjusting knob 112 is screwed in, it presses the left-right adjusting seat 123, so that the first reflective optical element 61 is rotatable about the Z-axis.

Preferably, an up-down reset spring 131 is provided between the mounting seat 121 and the up-down adjusting seat 122. When the up-down adjusting knob 111 is screwed in, it pushes a rear end of the up-down adjusting seat 122 to move downwardly and deforms the up-down reset spring 131, and a front end of the up-down adjusting seat 122 drives the first reflective element 61 to move upwardly simultaneously. When the up-down adjusting knob 111 is screwed out, the up-down reset spring 131 returns and drives the front end of the up-down adjusting seat 122 to move in a return direction. Preferably, the up-down reset spring 131 is located at an end of the up-down adjusting seat 122 adjacent to the up-down adjusting knob 111, so as to facilitate the force application and reset of the up-down reset spring 131. Preferably, the up-down adjusting seat 122 is provided with a fourth bore 1223 for accommodating the up-down reset spring 131. The up-down reset spring 131 protrudes from the fourth bore 1223 and comes into contact with the mounting seat 121.

The inclined side of the mounting seat 121 is further provided with an opening 1213 facing towards the first reflective optical element 61 and communicating with the receiving cavity 1210. The left-right adjusting seat 123 and the first reflective optical element 61 are exposed outside the accommodating cavity 1210 through the opening 1213, to facilitate the rotation of the first reflective optical element 61. Preferably, the opening 1213 is inclined. An angle of inclination of the opening 1213 coincides with an angle of inclination of the first reflective optical element 61. The mounting seat 121 has an edge defining the opening 1213. It will be appreciated that the edge will not interfere with the rotation of the first reflective optical element 61 in the up-down direction and left-right direction.

As shown in FIG. 7, the up-down adjusting seat 122 may also be provided with an extension portion 1224 exposed outside the accommodation cavity 1210. The extension portion 1224 is provided with a fifth bore 1225 extending along the X-axis, in which the left-right reset spring 132 is received. The left-right adjusting seat 123 is provided with a left-right adjusting contact point 1233, against which the left-right adjusting knob 112 abuts, and the left-right reset spring 132 protrudes from the fifth bore 1225 and comes into contact with the left-right adjusting contact point 1233. The fifth bore 1225, the left-right adjusting knobs 112, and the left-right adjusting contact point 1233 are located on the same straight line parallel to the X-axis. When the left-right adjusting knob 112 is screwed in, the left-right adjusting knob 112 pushes the left-right adjusting seat 123 to rotate about the Z-axis, and the left-right reset spring 132 is compressed; and when the left-right adjusting knob 112 is screwed out, the left-right reset spring 132 pushes the left-right adjusting seat 123 to rotate in a return direction. In this embodiment, the left-right adjusting contact point 1233 is disposed away from the first reflective optical element 61 with respect to the left-right adjusting shaft 1231, making it easy to rotate the left-right adjusting seat 123 by steering the left-right adjusting knob 112.

The installation steps of the adjusting component 10 of this embodiment are as follows: firstly, the left-right reset spring 132 is received in the fifth bore 1225, the left-right adjusting shaft 1231 is passed through the third bore 1221 from bottom to top with the left-right adjusting contact point 1233 of the left-right adjusting seat 123 aligned with the left-right reset spring 132, and then the left-right adjusting shaft 1231 is connected with the screw head 1232, thus the left-right adjusting seat 123 is connected to the up-down adjusting seat 122. Secondly, the up-down reset spring 131 is received in the fourth bore 1223, and the up-down adjusting shafts 1222 of the up-down adjusting seat 122 are respectively engaged in the two corresponding second bores 1211, so that the up-down adjusting seat 122 is received in the accommodating cavity 1210 of the mounting seat 121. Finally, the mounting seat 121 is fixed to the housing, and the up-down adjusting knobs 111 and the left-right adjusting knobs 112 are respectively engaged in the first through-hole and the second through-hole of the housing 20, thereby completing the installation of the adjusting component 10.

When the up-down adjusting knob 111 is screwed in, it pushes the up-down adjusting seat 122 to rotate about the X-axis, and the first reflective optical element 61 rotates upwardly, thereby realizing the upward movement of a target object image. When the up-down adjusting knob 111 is screwed out, the up-down reset spring 131 is released to push the up-down adjusting seat 122 and the first reflective optical element 61 to return, thereby realizing the downward movement of the target object image. When the left-right adjusting knob 112 is screwed in, the left-right adjusting seat 123 rotates to the right around the left-right adjusting shaft 1231, and the first reflective optical element 61 rotates to the right at the same time, thereby realizing the right movement of the target object image. When the left-right adjusting knob 112 is screwed out, the left-right reset spring 132 pushes the first reflective optical element 61 to return, thereby realizing the left movement of the target object image. Therefore, with the aid of the adjusting component 10, the first reflective optical element 61 of the present embodiment is adjustable in two degrees of freedom without interfering with each other.

FIG. 9 shows a laser ranging sight 100 according to a second embodiment of the present disclosure. This embodiment is similar to the first embodiment, and the same parts will not be described here. This embodiment differs from the first embodiment in that: the imaging device 50 is a digital imaging device. The imaging apparatus 50 includes a digital imaging display 51 and a digital lens 52. In the imaging optical path, the digital display 51 functions similar to the eyepiece of the first embodiment, and the digital lens 52 functions similar to the objective lens of the first embodiment. The image of the digital display 51 of this embodiment can be directly observed by eyes.

FIG. 10 shows a laser ranging sight 100 according to a third embodiment of the present disclosure. This embodiment is similar to the first embodiment, and the same parts will not be described here. This embodiment differs from the first embodiment in that: the imaging device 50 is a digital imaging device. The imaging device 50 includes a digital imaging sensor 51, a digital lens 52, a digital imaging display 53 and a digital imaging eyepiece 54. In the imaging optical path, the digital imaging eyepiece 54 and the digital imaging display 53 collectively function similar to the eyepiece of the first embodiment, and the digital lens 52 functions similar to the objective lens of the first embodiment. The image of the digital imaging display 53 of this embodiment is magnified by the digital imaging eyepiece 54 and then observed by user's eyes.

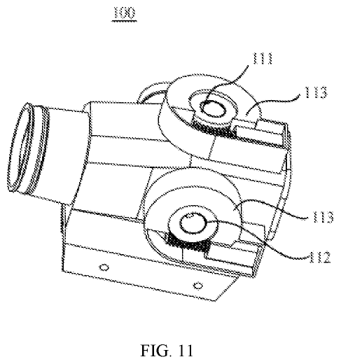

FIG. 11 shows a laser ranging sight 100 according to a fourth embodiment of the present disclosure. This embodiment is similar to the first embodiment, and the same parts will not be described here. This embodiment differs from the first embodiment in that: the adjusting component 10 further includes an electronically controlled adjusting element 113. The adjusting knob 11 of the adjusting component 10 of the first embodiment is manually operated, while the adjusting knob 11 of the adjusting component 10 of this embodiment is driven by the electronically controlled adjusting element 113. For example, the electrically controlled adjusting element 113 may include a motor and a screw rod. The screw rod is screwed with the adjusting knob 110, and the motor is used to drive the adjusting knob 110 to rotate. The adjusting component 10 may also include a sensor and a compensation and correction module. The sensor can sense the real-time ranging parameters such as pitch angle, wind speed and wind direction. The adjusting knob 11 is connected to the compensation and correction module, which compares the sensed real-time parameters with standard preset parameters to compensate and correct the measurement deviation, so as to reduce the influence caused by the change of pitch angle, wind speed and wind direction, thus improving the adaptability and accuracy of the adjustment.

The optical paths of the laser emitting device 30, the laser receiving device 40 and the imaging device 50 of the laser ranging sight 100 collectively form a ranging optical path, and the adjusting component 10 is disposed at the front side of the laser emitting device 30, the laser receiving device 40 and the imaging device 50, thus the ranging optical path can be adjusted by the adjusting component 10. Since the adjusting component 10 of the present disclosure is connected to the reflective optical element 60, therefore the ranging optical path can be adjusted by simply adjusting the steering of the reflective optical element 60 through the adjustment component 10. Compared with the known outer adjusting component driving the whole structure to move, the adjusting speed is improved and the operation difficulty is reduced.

The technical features of the above-described embodiments may be arbitrarily combined, and not all possible combinations of the technical features in the above-described embodiments are described for the sake of concise description. However, as long as there is no contradiction in the combinations of these technical features, they should be considered to belong to the scope of the specification.

The above-described embodiments are merely illustrative of several embodiments of the disclosure and the description thereof is more specific and detailed, but cannot therefore be construed as limitations to the scope of the application. It should be noted that a number of variations and modifications may be made to those of ordinary skill in the art without departing from the concept of the embodiments of the disclosure, and those fall within the scope of protection of the embodiments of the disclosure. Therefore, the scope of protection of the embodiment of the disclosure shall be subject to the appended claims.

1. A laser ranging sight, comprising: a housing; and
a laser emitting device, a laser receiving device, and an imaging device arranged in the housing,
wherein optical paths of the laser emitting device, the receiving device and the imaging device collectively form a ranging optical path,
wherein the laser ranging sight further comprises an adjusting component mounted on the housing, and the adjusting component is disposed at a front side of the laser emitting device, the laser receiving device and the imaging device, and the adjusting component is operatable to change an orientation of the ranging optical path.

2. The laser ranging sight according to claim 1, further comprising a reflective optical element provided at the front side of the laser emitting device, wherein the laser receiving device and the imaging device, the adjusting component is connected to the reflective optical element, and the orientation of the ranging optical path is changed by steering the reflective optical element.

3. The laser ranging sight according to claim 1, wherein the imaging device is a digital imaging device or an optical imaging device.

4. The laser ranging sight according to claim 2, wherein the reflective optical element is a lens or a prism.

5. The laser ranging sight according to claim 1, wherein the adjusting component is manually operated or electrically driven.

6. The laser ranging sight according to claim 4, wherein the adjusting component comprises an adjusting knob and an adjusting seat, the adjusting knob is partially exposed outside the housing, the adjusting seat is connected to the reflective optical element, and when the adjusting knob is operated, the adjusting knob acts on the adjusting seat and drives the reflective optical element to rotate.

7. The laser ranging sight according to claim 6, wherein the adjusting seat is provided with a reset spring, and the reset spring provides a return force for driving the adjusting seat together with the reflective optical element to rotate in a return direction.

8. The laser ranging sight according to claim 6, wherein the adjusting knob comprises an up-down adjusting knob and the adjusting seat comprises an up-down adjusting seat, the up-down adjusting knob abuts against the adjusting seat, and the up-down adjusting seat is rotatably connected to the housing and is rotatable relative to the housing about a first axis.

9. The laser ranging sight according to claim 8, wherein the adjusting knob further comprises a left-right adjusting knob and the adjusting seat further comprises a left-right adjusting seat, the left-right adjusting knob abuts against the left-right adjusting seat, the left-right adjusting seat is rotatably connected to the up-down adjusting seat and is rotatable about a second axis with respect to the up-down adjusting seat, and the second axis is perpendicular to the first axis.

10. The laser ranging sight according to claim 9, wherein the reflective optical element is connected to one of the up-down adjusting seat and the left-right adjusting seat.

11. The laser ranging sight according to claim 10, wherein the adjusting seat further comprises a mounting seat fixed to the housing, and wherein the mounting seat, the up-down adjusting seat and the left-right adjusting seat are sequentially disposed along the second axis, and the up-down adjusting seat is rotatably connected to the mounting seat.

12. The laser ranging sight according to claim 11, wherein the mounting seat is provided with two first bores spaced apart along the first axis, and the up-down adjusting seat is provided with two up-down adjusting shafts that engage in corresponding two first bores respectively, such that the up-down adjusting seat is rotatably connected to the mounting seat through the two up-down adjusting shafts.

13. The laser ranging sight according to claim 9, wherein the up-down adjusting seat is provided with a second bore penetrating therethrough along the second axis, the left-right adjusting seat is protruded with a left-right adjusting shaft extending along the second axis, and the left-right adjusting shaft is engaged with the second bore, such that the left-right adjusting seat is rotatably connected to the up-down adjusting seat through the left-right adjusting shaft.

14. The laser ranging sight according to claim 11, wherein the mounting base is provided with a third bore penetrating therethrough along the second axis, and the up-down adjusting knob passes through the third bore and abuts against the up-down adjusting seat.

15. The laser ranging sight according to claim 11, wherein an up-down reset spring is provided between the mounting seat and the up-down adjusting seat, when the up-down adjusting knob is screwed in, the up-down adjusting knob pushes an end of the up-down adjusting seat downwardly and deforms the up-down reset spring; and when the up-down adjusting knob is screwed out, the up-down reset spring returns and drives the end of the up-down adjusting seat to rotate in a return direction.

16. The laser ranging sight according to claim 11, wherein the mounting seat is formed with an accommodation cavity, the up-down adjusting seat is at least partially disposed within the accommodation cavity and is rotatably connected to the mounting seat, the mounting seat has an opening towards the reflective optical element, and the left-right adjusting seat and the reflective optical element are exposed outside the accommodation cavity through the opening.

17. The laser ranging sight according to claim 16, wherein the opening is inclined, and an inclination angle of the opening coincides with an inclination angle of the reflective optical element.

18. The laser ranging sight according to claim 9, wherein the up-down adjusting seat is provided with a left-right reset spring, the left-right adjusting knob abuts against a contact point of the left-right adjusting seat, when the left-right adjusting knob is screwed in, the left-right adjusting knob pushes the left-right adjusting seat to rotate about the second axis, and the left-right reset spring is compressed; and when the left-right adjusting knob is screwed out, the left-right reset spring pushes the left-right adjusting seat to rotate in a return direction.

19. The laser ranging sight according to claim 4, further comprising another reflective optical element provided opposite the reflective optical element, wherein the another reflective optical element is fixedly disposed in the housing.

20. The laser ranging sight according to claim 1, wherein the laser emitting device and the laser receiving device are disposed in parallel on two sides of the imaging device.
